(19) United States
(12) Patent Application Publication
(10) Pub. No.: US 2015/0170864 A1
(43) Pub. Date: Jun. 18, 2015

(54) THREE ELECTRODE CIRCUIT ELEMENT

(71) Applicant: Altera Corporation, San Jose, CA (US)

(72) Inventor: Michael Brassington, Los Altos, CA (US)

(21) Appl. No.: 14/297,408

(22) Filed: Jun. 5, 2014

Related U.S. Application Data
(60) Provisional application No. 61/916,472, filed on Dec. 16, 2013.

(51) Int. Cl. H01J 1/308

(52) U.S. Cl. CPC H01J 1/308

(57) ABSTRACT

In an illustrative embodiment, a three electrode circuit element comprises an insulating material, a cavity in the insulating material, first and second electrodes spaced apart in the cavity by a distance small enough that electron emission is caused when suitable operating voltages are applied to the first and second electrodes, and a gate electrode near one of the first and second electrodes. A voltage applied to the gate electrode can control current flow between the first and second electrodes. The circuit element may be realized in a planar structure in which the electrodes are formed in substantially the same plane; or it may be a multi-layer device in which some or all of the electrodes are in separate layers of conductive material. Methods for forming the circuit element are also disclosed. Illustrative applications of the three electrode circuit element to provide standard circuit functions are also disclosed.

### BACKGROUND

This concerns electron field emission (a/k/a field electron emission or field emission) which relates to the emission of electrons in an electrostatic field. This phenomenon has been known since at least the late nineteenth century and is understood to be the result of quantum tunneling of electrons. In some circumstances, electron field emission is something to be avoided. However, it is widely employed in other areas such as electron microscopy. The present application relates to circuit elements that utilize electron field emission and to methods for making and using such circuit elements.

### SUMMARY

In an illustrative embodiment, a three electrode circuit element comprises an insulating material, a cavity in the insulating material, first and second electrodes spaced apart in the cavity by a distance small enough that electron emission is caused when suitable operating voltages are applied to the first and second electrodes, and a gate electrode near one of the first and second electrodes but insulated from it. A voltage applied to the gate electrode can control current flow between the first and second electrodes, thereby enabling a variety of circuit functions.

The circuit element may be realized in a planar structure in which the electrodes are formed in substantially the same plane; or it may be a multi-layer device in which some or all of the electrodes are separate layers of conductive material. Methods for fainting the circuit element are also disclosed.

The three electrode circuit element has numerous advantages. It has a simple construction and is relatively easy to make. It has excellent operating characteristics including low power requirements, low sensitivity to temperature and operating environment, immunity from single event upset (SEU), and very high switching speed.

Advantageously, the three electrode circuit element can be implemented in the back end structure of an otherwise conventional integrated circuit. The back end structure of an integrated circuit is the interconnection wiring formed in alternating layers of metallization and dielectric on top of the semiconductor substrate in which the transistors are made. See, chapter 3 of Weste et al., CMOS VLSI Design A Circuits and Systems Perspective (4^{th} Ed., Addison-Wesley 2011); chapter 11 of J. D. Plummer et al., Silicon VLSI Technology Fundamentals, Practice and Modeling (Prentice Hall 2000). Since three electrode circuit elements can be implemented in the back end structure while providing similar functionality as that of transistors, they can be used to increase the overall functionality of the integrated circuit significantly without requiring any increase in the amount of space the integrated circuit occupies on a circuit board.

### BRIEF DESCRIPTION OF THE DRAWINGS

These and other objects and advantages of the present invention will be apparent to those of ordinary skill in the art in view of the following detailed description in which:

FIG. 1 is a schematic view of a first illustrative embodiment of the invention;

FIGS. 2A and 2B are top views of second and third illustrative embodiments of the invention;

FIGS. 3A and 3B are side views of fourth and fifth illustrative embodiments of the invention;

FIG. 4 is a flow chart of an illustrative process for making a circuit element similar to that of FIG. 2A;

FIGS. 5A-5J depict cross-sections of a circuit element at certain stages of its fabrication in accordance with the process of FIG. 4;

FIG. 6 is a flow chart of an illustrative process for making a circuit element similar to that of FIG. 3A;

FIGS. 7A-7D depict cross-sections and a top view of a circuit element at certain stages of its fabrication in accordance with the process of FIG. 6;

FIG. 8 is a flow chart of an illustrative process for making a circuit element similar to that of FIG. 3B;

FIGS. 9A-9E depict cross-sections of a circuit element at certain stages of its fabrication in accordance with the process of FIG. 8;

FIG. 10 is a flow chart of an illustrative process for making a circuit element similar to that of FIG. 11A;

FIGS. 11A-11G depict cross-sections and a top view of a circuit element at certain stages of its fabrication in accordance with the process of FIG. 10;

FIG. 12 is a schematic diagram of an illustrative embodiment of an inverter circuit using illustrative circuit elements of the invention;

FIGS. 13A and 13B are schematic diagrams of illustrative embodiments of a NAND circuit and an AND circuit using illustrative circuit elements of the invention;

FIGS. 14A and 14B are schematic diagrams of illustrative embodiments of a NOR circuit and an OR circuit using illustrative circuit elements of the invention;

FIG. 15 is a schematic diagram of an illustrative embodiment of a SRAM circuit using illustrative circuit elements of the invention; and

FIGS. 16A-16H are a flow chart and side views depicting an illustrative process for making multiple circuit elements such as those of FIG. 2A;

### DETAILED DESCRIPTION

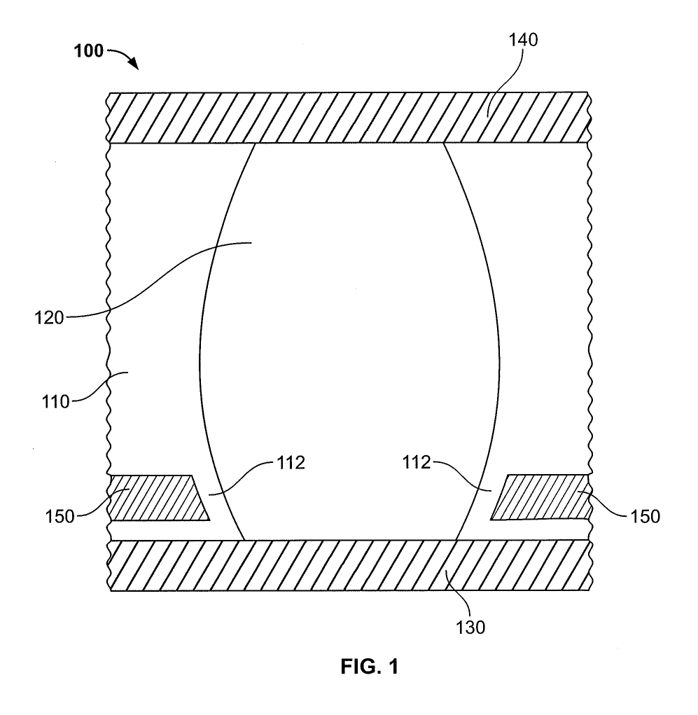

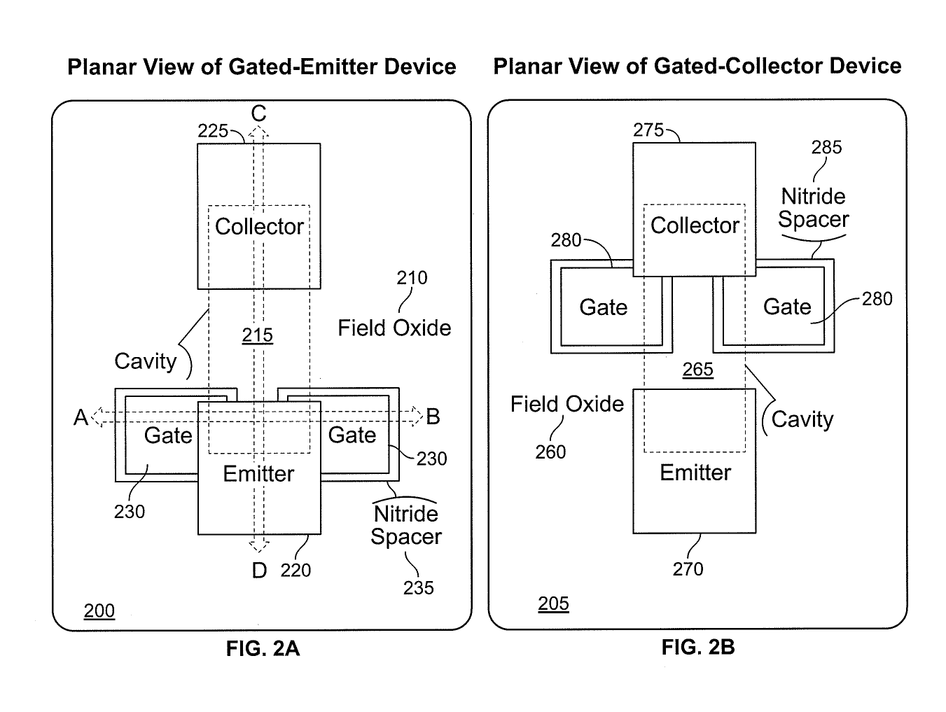

FIG. 1 is a schematic view of an illustrative embodiment 100 of the invention. Embodiment 100 comprises an insulating material 110, a cavity 120 in the insulating material, first and second electrodes 130, 140 at opposite ends of cavity 120, and a gate electrode 150 between first and second electrodes 130, 140 but insulated from them by portions 112 of insulating material 110. Gate electrode 150 is not equidistant between the first and second electrodes but is located closer to one or the other of these electrodes as described more fully below in conjunction with FIGS. 2A and 2B.

First and second electrodes 130, 140 are spaced apart by a distance that is sufficiently small that electron emission occurs from one of the electrodes when suitable voltages are applied to the first and second electrodes. Optionally, the electron emitting electrode, or emitter, may be shaped as with one or more sharp or pointy edges and/or coated with an appropriate low work function material so as to stimulate electron emission. The other electrode is the electron collecting electrode, or collector.

It is known that electron field emission occurs in electrostatic fields greater than approximately one GigaVolt per meter (GV/m) depending on the work function and shape of the emitting electrode. Illustratively, the operating voltage applied to the emitting electrode is 0 Volts and the operating voltage applied to the collecting electrode is on the order of 20 Volts or less; the spacing between the first and second electrodes is on the order of 200 nanometers (nm.) or less; and the emitting electrode is shaped or coated or both so that electron emission is generated when the operating voltages are applied to the electrodes.

A voltage applied to gate electrode 150 can control current flow between the emitter and collector electrodes. In particular, for the case where the gate electrode 150 is near the emitter electrode, a high voltage applied to the gate electrode will prevent current flow between the emitter electrode and the collector electrode while a low voltage will permit current flow between the emitter electrode and the collector electrode. Conversely, for the case where the gate electrode 150 is near the collector electrode, a high voltage applied to the gate electrode will permit current flow between the emitter electrode and the collector electrode while a low voltage will prevent current flow between the emitter electrode and the collector electrode. Illustratively, the high voltage is comparable to the voltage applied to the collector electrode and the low voltage is comparable to the voltage applied to the emitter electrode.

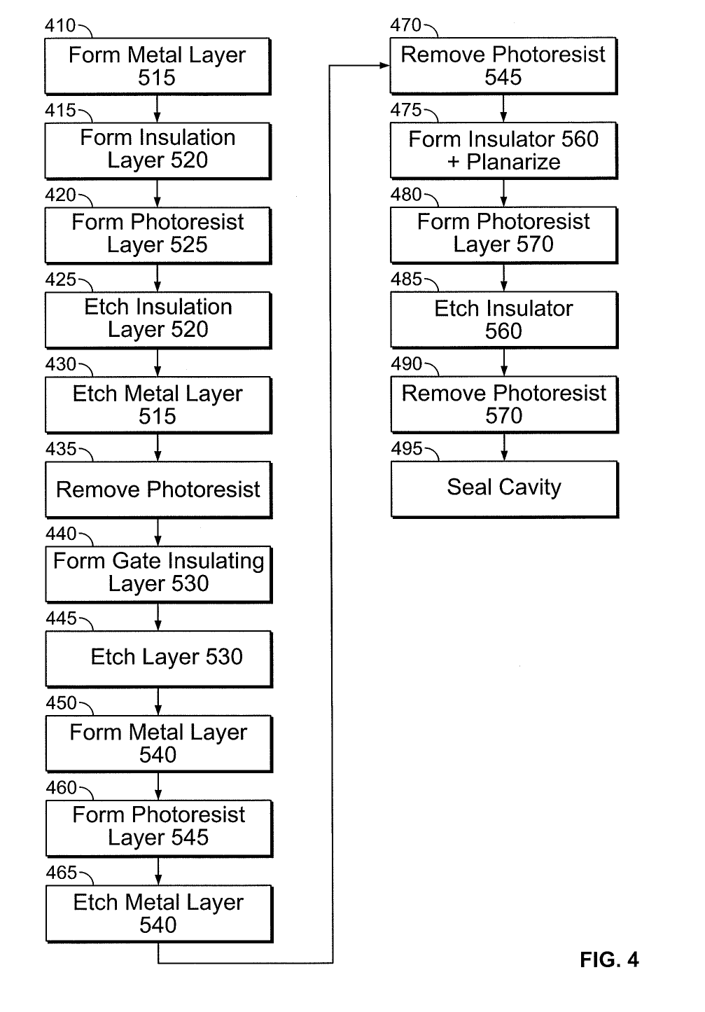

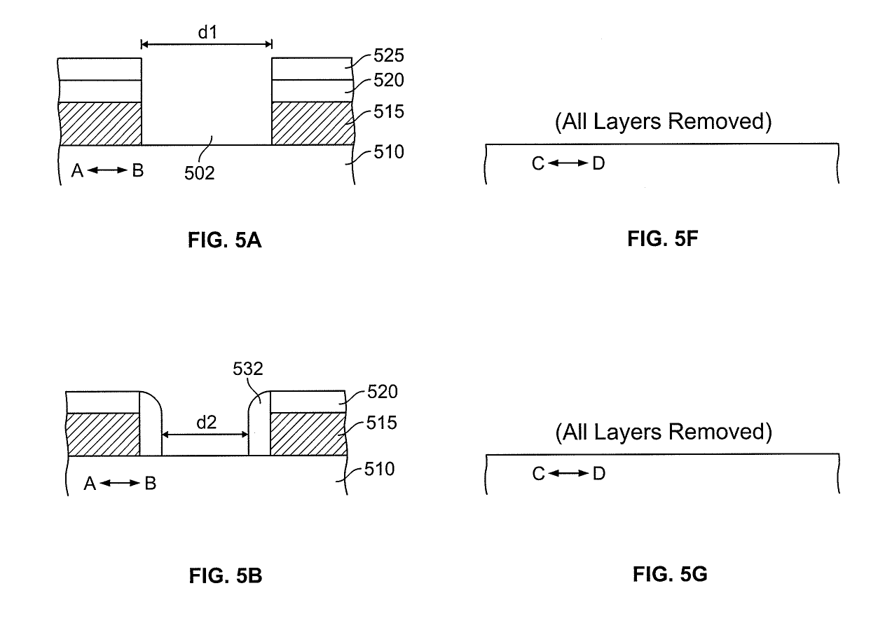

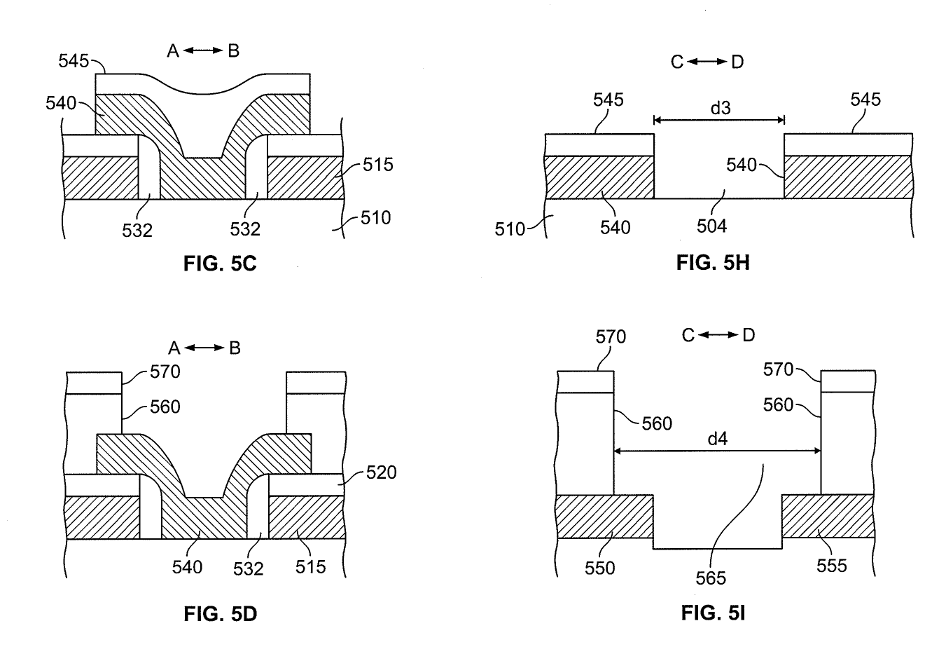

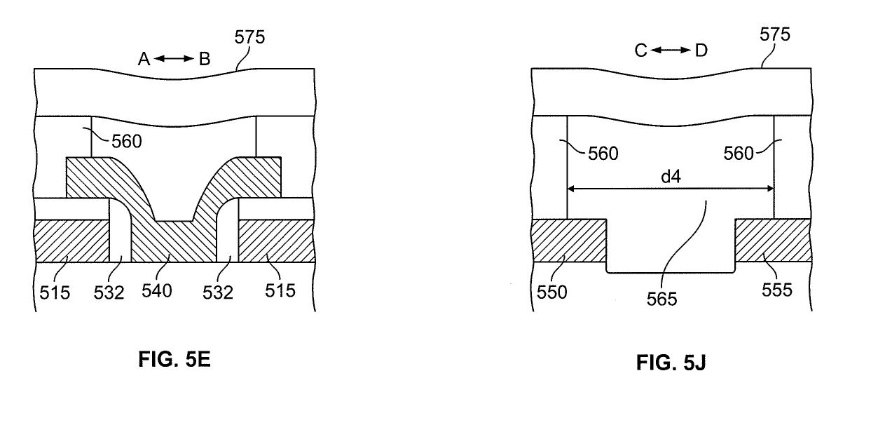

FIGS. 2A and 2B are top views of illustrative embodiments 200, 205, respectively, of the circuit element of FIG. 1 in which the gate electrode is formed near the emitter (FIG. 2A) and near the collector (FIG. 2B). Processes for making embodiments 200, 205 are set forth in conjunction with FIGS. 4 and 5A-5J. Illustratively, embodiments 200, 205 might be formed in a substantially planar structure such as a portion of the back end of an integrated circuit.

Embodiment 200 comprises an insulating material 210, a cavity 215 in the insulating material, emitter and collector electrodes 220, 225 at opposite ends of cavity 215, and a gate electrode 230 on opposite sides of emitter electrode 220 but insulated from it by a nitride spacer 235. Emitter and collector electrodes 220, 225 are spaced apart by a distance that is sufficiently small that electron emission occurs from the emitter electrode when suitable operating voltages are applied to the emitter and collector electrodes. A voltage applied to gate electrode 230 controls current flow between the emitter and collector electrodes. Specifically, a high voltage applied to gate electrode 230 prevents current flow in embodiment 200 while a low voltage permits current flow.

Embodiment 205 includes the same elements but the gate electrode is near the collector electrode. Specifically, embodiment 205 comprises an insulating material 260, a cavity 265 in the insulating material, emitter and collector electrodes 270, 275 at opposite ends of cavity 265, and a gate electrode 280 near collector electrode 275 but insulated from it by a nitride spacer 285. Again, emitter and collector electrodes 270, 275 are spaced apart by a distance that is sufficiently small that electron emission occurs from the emitter electrode when suitable operating voltages are applied to the emitter and collector electrodes. A voltage applied to gate electrode 280 controls current flow between the emitter and collector electrodes so that a high voltage applied to gate electrode 280 permits current flow in embodiment 205 while a low voltage prevents current flow.

Illustrative operating voltages for both embodiments 200, 205 are on the order of 0 Volts for the emitters and 20 Volts or less for the collectors; and the spacing between the emitter and collector electrodes is on the order of 200 nm. or less; and the low and high voltages applied to the gate electrode are comparable to those applied to the emitter and collector electrodes 220, 225 and 270, 275. Optionally, the emitter electrode may be shaped as with one or more sharp or pointy edges or coated with an appropriate low work function material so as to stimulate electron emission and reduce the electric field required for electron emission.

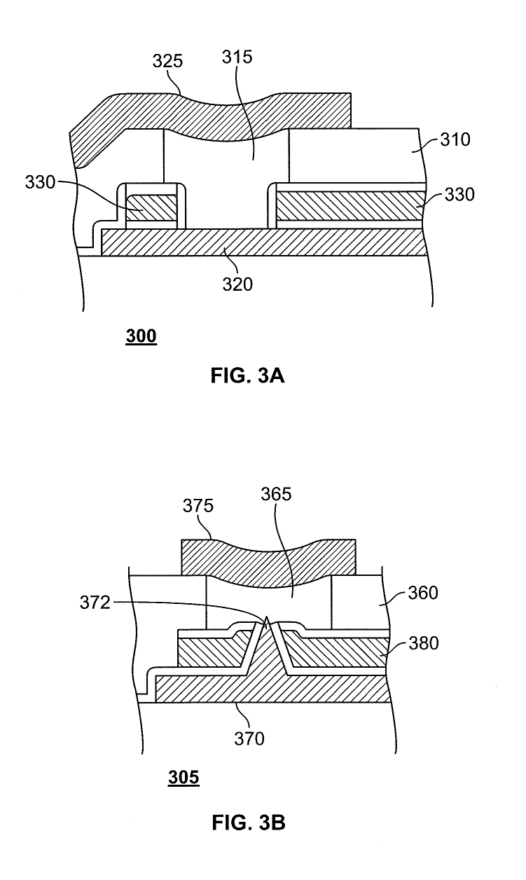

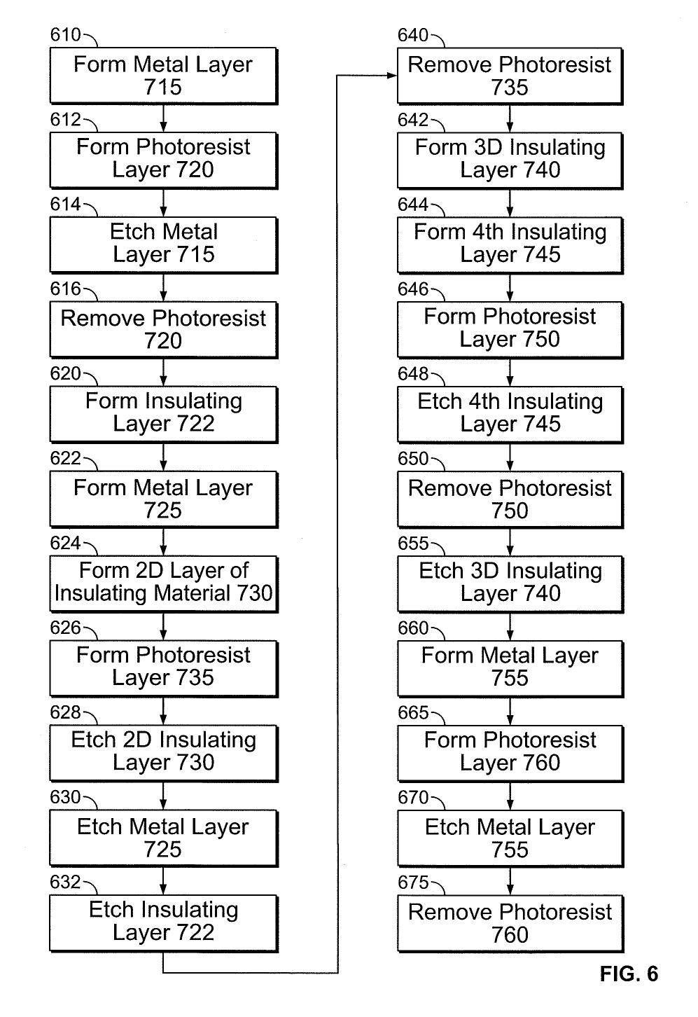

FIGS. 3A and 3B are side views of illustrative embodiments 300, 305, respectively, of the circuit element of FIG. 1 as might be formed in a multi-layer structure such as the back end of an integrated circuit. Processes for making these embodiments are described in conjunction with FIGS. 6, 7A-7E, 8, and 9A-9E.

Embodiment 300 comprises an insulating material 310, a cavity 315 in the insulating material, emitter and collector electrodes 320, 325 at opposite ends of cavity 315, and a gate electrode 330 near emitter electrode 320 but insulated from it. Alternately, gate electrode 330 could be located near collector electrode 325 as in embodiment 205. Emitter and collector electrodes 320, 325 are spaced apart by a distance that is sufficiently small that electron emission occurs from the emitter electrode when suitable operating voltages are applied to the emitter and collector electrodes. A voltage applied to gate electrode 330 can control current flow between the emitter and collector electrodes.

Optionally, the emitter electrode may be shaped as with one or more sharp or pointy edges or coated with an appropriate low work function material so as to stimulate electron emission. An emitter electrode with a pointed edge 372 is shown in embodiment 305 of FIG. 3B. In other respects, embodiment 305 is similar to embodiment 300. Embodiment 305 comprises an insulating material 360, a cavity 365 in the insulating material, emitter and collector electrodes 370, 375 at opposite ends of cavity 365, and a gate electrode 380 near emitter electrode 370 but insulated from it. Alternately, gate electrode 380 could be located near collector electrode 375 as in embodiment 205. Emitter and collector electrodes 370, 375 are spaced apart by a distance that is sufficiently small that electron emission occurs from the emitter electrode when suitable operating voltages are applied to the emitter and collector electrodes. A voltage applied to gate electrode 380 can control current flow between the emitter and collector electrodes.

Illustratively, the operating voltages for embodiments 300, 305 are on the order of 0 Volts for the emitters and 20 Volts or less for the collectors; and the spacing between the first and second electrodes is on the order of 200 nm. or less; and the low and high voltages applied to the gate electrode are comparable to those applied to the emitter and collector electrodes 320, 325 and 370, 375.

FIG. 4 is a flow chart depicting an illustrative embodiment of a process of the invention for forming a circuit element such as that of FIG. 2A. Portions of the description of the flow chart refer to the cross-sectional views of FIGS. 5A-5J where the views of FIGS. 5A-5E are transverse cross-sectional views of the device of FIG. 2A made along line AB and the views of FIGS. 5F-5J are longitudinal cross-sectional views made along line CD of FIG. 2A. The process for making a circuit element such as that of FIG. 2B is similar to the process of FIG. 4 except that the gate electrode is located near the collector electrode instead of near the emitter electrode.

The process of FIG. 4 begins at step 410 with the formation of a layer of metal 515 (see FIG. 5A) on a substantially flat insulating substrate 510. Metal layer 515 will be used to form the gate electrode. Illustrative examples of suitable metals for use in the layer are copper, aluminum/copper, and tungsten. Illustratively, the substantially flat insulating substrate 510 can be formed of a silicon oxide or silicon nitride. In one embodiment of the invention, the circuit element may be formed on one of the dielectric layers in the back end structure of interconnects on an integrated circuit. In such an embodiment, the insulating substrate may be formed simultaneously on a multitude of identical integrated circuits that are being formed on a single wafer of a semiconductor material. The insulating substrate may include electrically conducting vias that connect to various portions of the layer of metal that is formed in step 410.

At step 415, a gate insulation layer 520 is formed on metal layer 515. Illustratively, the insulation layer is a nitride.

Next, a photolithographic process is used to define the shape of the gate electrode. First, at step 420, a layer of a suitable photoresist 525 is formed on gate insulation layer 520; and the photoresist layer is exposed to a pattern of actinic radiation that defines the shape of the gate electrode. At step 425, a selective, anisotropic etch is performed to etch insulation layer 520 down to metal layer 515. Another selective, anisotropic etch is then performed at step 430 to etch metal layer 515 down to substrate 510.

The result is shown in FIG. 5A which is a transverse section along line AB of FIG. 2A. As shown in FIG. 5A, the gate electrode is divided in two with a gap 502 having a distance of d1 separating the two halves of the gate electrode. As shown in FIG. 5F, at this stage in the process of FIG. 4 there is nothing on substrate 510 on the longitudinal section along line CD of FIG. 2A.

At step 435, the remaining portions of photoresist layer 525 are removed. A gate insulating layer 530 is then formed at step 440 on the exposed upper surfaces of gate insulating layer 520, the sidewalls of metal layer 515, and the portion of substrate 510 in gap 502. Preferably, insulating layer 530 is the same material as that of insulating layer 520; and illustratively this material is a nitride. The thickness of this layer determines the distance d2 between the insulating layers on the sidewalls. At step 445, a selective, anisotropic etch is performed to remove the portions of gate insulating layer 530 that extend in the horizontal direction, thereby exposing the portion of substrate 510 in gap 502 and leaving spacers 532 on the sidewalls of metal layer 515.

The result is shown in FIG. 5B which is a section along line AB of FIG. 2A. Again, as shown in FIG. 5G, at this stage in the process of FIG. 4 there is nothing on substrate 510 on the longitudinal section along line CD of FIG. 2A.

The emitter and collector electrodes are then formed First at step 450, a metal layer 540 is formed on the exposed portions of the substrate 510 including the portions in gap 502, on the outer surfaces of the spacers, and on the upper surfaces of insulating layer 530. A photolithographic process is then used to form the emitter and collector electrodes by separating metal layer 540 into two. First, at step 460, a layer of a suitable photoresist 545 is formed on metal layer 540; and the photoresist layer is exposed to a pattern of actinic radiation that defines the shape of the emitter and collector electrodes. At step 465, a selective, anisotropic etch is performed to etch metal layer 540 down to substrate 510 thereby forming a gap 504 between the emitter and collector electrodes.

The result is shown in the transverse and longitudinal sections of FIGS. 5C and 5H where the emitter electrode is identified by element number 550 and the collector electrode by element number 555; and the distance between these two electrodes across gap 504 is d3.

The remaining portions of photoresist layer 545 are then removed at step 470. Next, at step 475, a layer of a thick insulator 560 is formed on the upper surface; and this layer is planarized, for example, using chemical mechanical polishing (CMP). A photolithographic process is then used to form a cavity 565 in the insulating layers. First, at step 480, a layer of a suitable photoresist 570 is formed on insulator 560; and the photoresist layer is exposed to a pattern of actinic radiation that defines the shape of the cavity. At step 485, a selective, anisotropic etch is performed to etch insulator 560 to form cavity 565 in which emitter and collector electrodes 550, 555 are exposed and any portion of insulator 560 between these electrodes is removed down to substrate 510. A moderate amount of overetching of the substrate may also be advantageous.

The result is shown in the transverse and longitudinal sections of FIGS. 5D and 5I where the distance d4 is the length of cavity 565.

At step 490, the remaining portions of photoresist layer 570 are removed. And at step 495, cavity 565 is sealed by covering it with a suitable insulating layer 575. Illustratively, layer 575 may be a viscous, spun-on glass.

The result is shown in the transverse and longitudinal sections of FIGS. 5E and 5J.

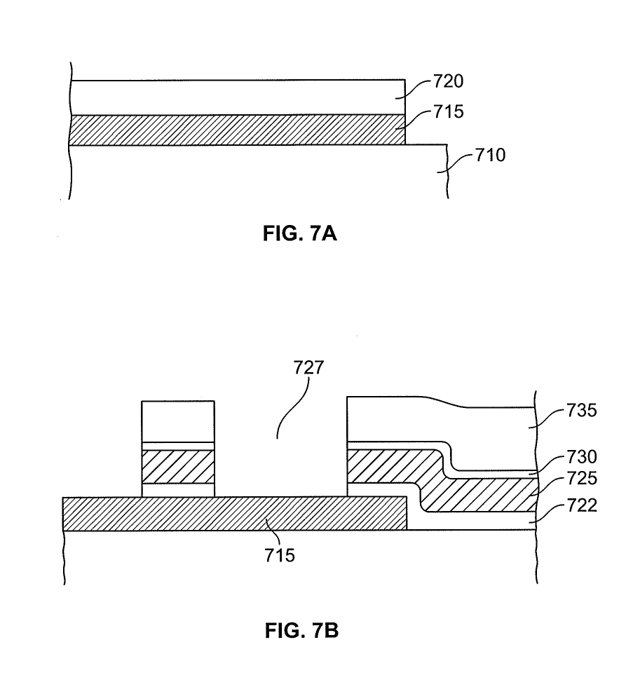

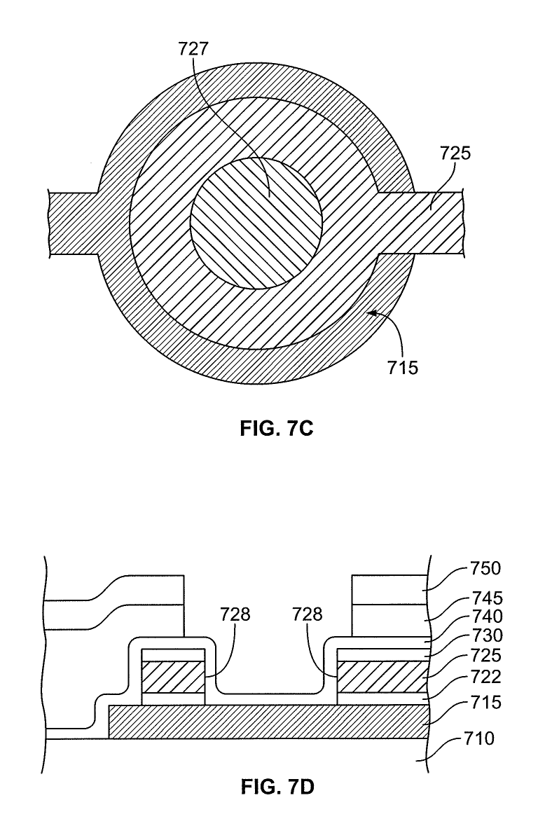

FIG. 6 is a flow chart depicting an illustrative embodiment of a process of the invention for forming a circuit element such as that of FIG. 3A. Portions of the description of the flow chart refer to the cross-sectional views of FIGS. 7A, 7B, and 7D, and the top view of FIG. 7C. The process begins at step 610 with the formation of a layer of metal 715 (see FIG. 7A) on a substantially flat insulating substrate 710. Metal layer 715 will be used to form the emitter electrode. Illustrative examples of suitable metals for use in the layer are copper, aluminum/copper, and tungsten. Illustratively, the substantially flat insulating substrate 710 can be formed of a silicon oxide or silicon nitride. In one embodiment of the invention, the circuit element may be formed on one of the dielectric layers in the back end structure of interconnects on an integrated circuit. In such an embodiment, the insulating substrate may be formed simultaneously on a multitude of identical integrated circuits that are being formed on a single wafer of a semiconductor material. The insulating substrate may include electrically conducting vias that connect to various portions of the layer of metal that is formed in step 610.

A photolithographic process is then used to form the emitter electrode by shaping metal layer 715. First, at step 612, a layer of a suitable photoresist 720 is formed on metal layer 715; and the photoresist layer is exposed to a pattern of actinic radiation that defines the shape of the emitter electrodes. Photoresist layer 720, metal layer 715 and substrate 710 are shown in FIG. 7A. At step 614, a selective, anisotropic etch is performed to etch metal layer 715 down to substrate 710 to produce the final shape of the emitter electrode. The remaining portions of photoresist layer 720 are then removed in step 616.

The gate electrode is then formed. At step 620, a layer of an insulating material 722 is formed on the emitter electrode. Next, a layer of metal 725 is formed at step 622 on insulating layer 722; and at step 624 a second layer of insulating material 730 is formed on metal layer 725.

A photolithographic process is then used to shape metal layer 725 into the gate electrode. First, at step 626, a layer of a suitable photoresist 735 is formed on second insulating layer 730; and the photoresist layer is exposed to a pattern of actinic radiation that defines the shape of the gate electrode. Illustratively, the gate electrode may be an annulus; but other shapes may be used in the practice of the invention. At step 628, a selective, anisotropic etch is performed to etch second insulating layer 730 down to metal layer 725. At step 630, a selective, anisotropic etch is performed to etch metal layer 725 down to insulating layer 722. At step 632, a selective, anisotropic etch is performed to etch insulating layer 722 down to metal layer 715 of the emitter electrode.

The result at this stage of the process is shown in the cross-section of FIG. 7B and the top view of FIG. 7C where there is a cavity 727 above metal layer 715 of the emitter electrode and between the sides of metal layer 725 of the gate electrode.

Next, an insulator is formed around the gate electrode. At step 640, the remaining portions of photoresist layer 735 are removed. At step 642, a third layer of an insulating material 740 is formed on the upper surfaces of second insulating layer 730, on the sidewalls 728 of metal layer 725 of the gate electrode, and on the exposed surface of the metal layer 715 of the emitter electrode. Illustratively, third insulating layer 740 is a nitride. A fourth insulating layer 745 is then formed at step 644 on third insulating layer 740. Illustratively, fourth insulating layer 745 is an oxide.

A photolithographic process is then used to form the cavity. First, at step 646, a layer of a suitable photoresist 750 is formed on fourth insulating layer 745; and the photoresist layer is exposed to a pattern of actinic radiation that defines the shape of the cavity. At step 648, a selective, anisotropic etch is performed to etch fourth insulating layer 745 down to third insulating layer 740.

FIG. 7D is a cross-section that depicts the circuit element at this stage in the process.

At step 650, the remaining portions of photoresist layer 750 are removed. At step 650, a selective, anisotropic etch is performed to etch third insulating layer 740 down to metal layer 715 while leaving in place on sidewalls 728 spacers that insulate metal layer 725 of the gate electrode from the cavity.

A collector electrode is then formed. At step 660, a layer of metal 755 is formed on fourth insulating layer 745. A photolithographic process is then used to shape the collector. First, at step 665, a layer of a suitable photoresist 760 is formed on metal layer 755; and the photoresist layer is exposed to a pattern of actinic radiation that defines the shape of the collector electrode. At step 670, a selective, anisotropic etch is performed to etch metal layer 755 down to fourth insulating layer 745. The remaining portions of photoresist layer 760 are then removed at step 675 leaving the completed circuit element shown in FIG. 3A.

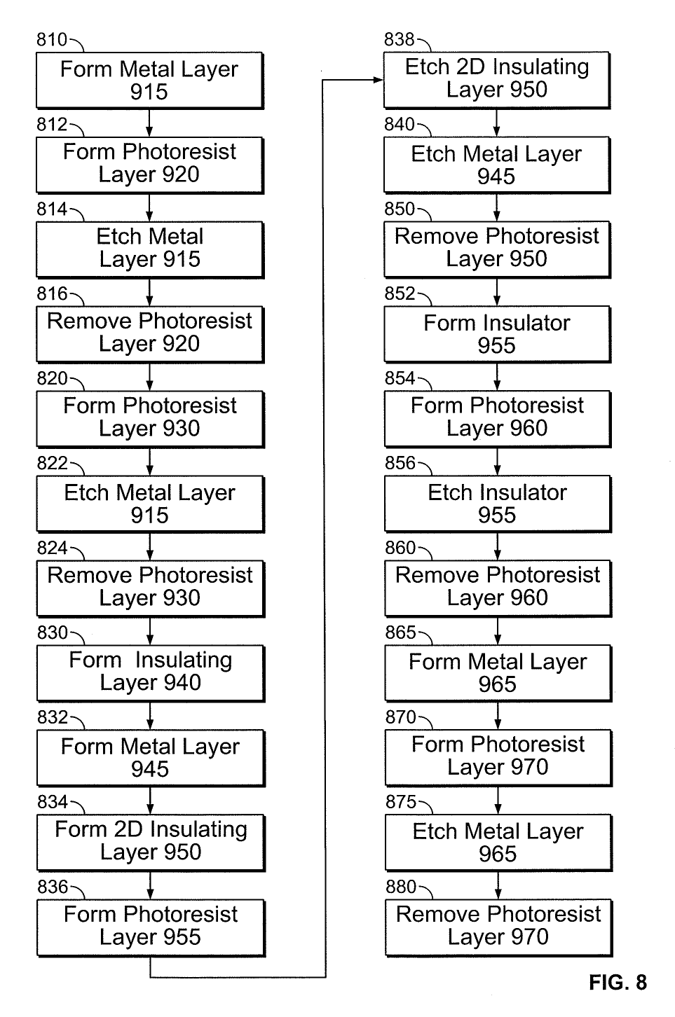

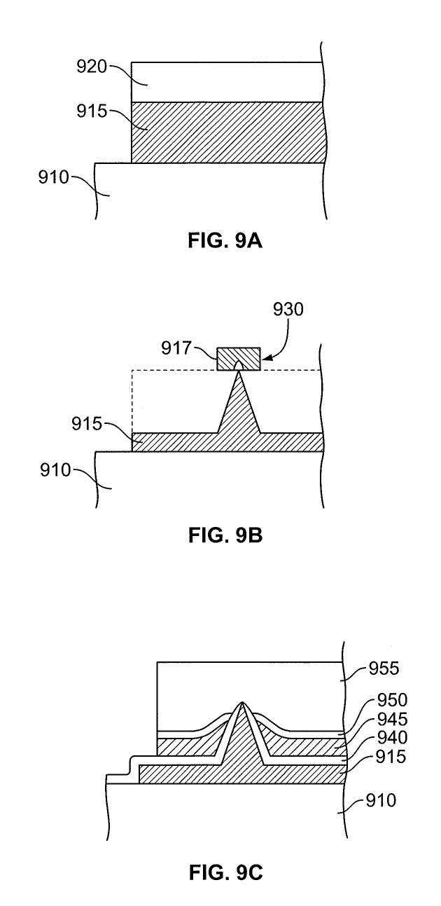

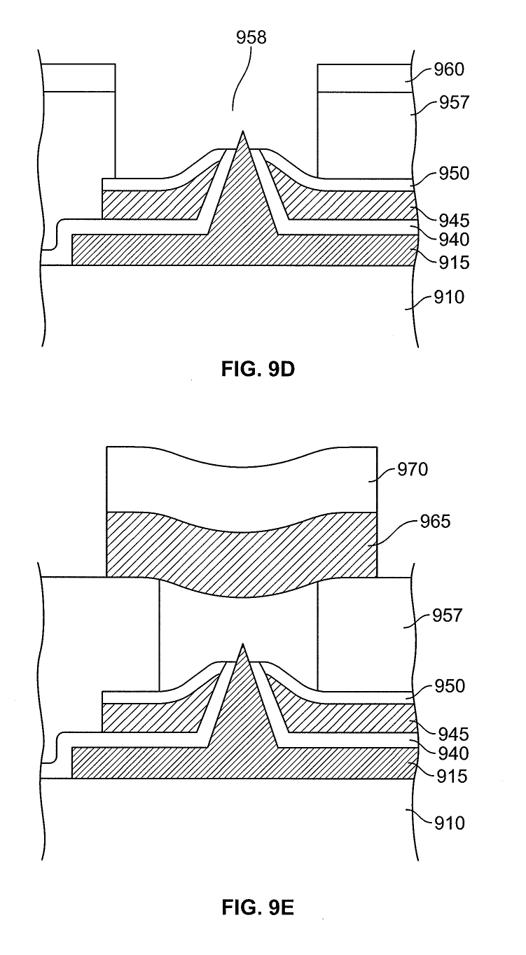

FIG. 8 is a flow chart depicting an illustrative embodiment of a process of the invention for forming a circuit element such as that of FIG. 3B. Portions of the description of the flow chart refer to the cross-sectional views of FIGS. 9A-9E. The process begins at step 810 with the formation of a layer of metal 915 (see FIG. 9A) on a substantially flat insulating substrate 910. Metal layer 915 will be used to form the emitter electrode. Illustrative examples of suitable metals for use in the layer are copper, aluminum/copper, and tungsten. Illustratively, the substantially flat insulating substrate 910 can be formed of a silicon oxide or silicon nitride. In one embodiment of the invention, the circuit element may be formed on one of the dielectric layers in the back end structure of interconnects on an integrated circuit. In such an embodiment, the insulating substrate may be formed simultaneously on a multitude of identical integrated circuits that are being formed on a single wafer of a semiconductor material. The insulating substrate may include electrically conducting vias that connect to various portions of the layer of metal that is formed in step 810.

A photolithographic process is then used to form the emitter electrode by shaping metal layer 915. First, at step 812, a layer of a suitable photoresist 920 is formed on metal layer 915; and the photoresist layer is exposed to a pattern of actinic radiation that defines the shape of the emitter electrodes. Photoresist layer 920, metal layer 915 and substrate 910 are shown in FIG. 9A. At step 814, a selective, anisotropic etch is performed to etch metal layer 915 down to substrate 910 to produce its final shape. The remaining portions of photoresist layer 920 are then removed in step 816.

A second photolithographic process is then used to shape the emitter electrode so as to have a sharp edge 917. First, at step 820, a layer of a suitable photoresist 930 is formed on metal layer 915; and the photoresist layer is exposed to a pattern of actinic radiation to produce a pattern that overlies the intended location of the sharp edge of the emitter electrodes. At step 822, a selective etch is performed to etch metal layer 915 to produce its final shape. This etch undercuts the pattern of photoresist from both sides and the etch is continued until the final shape of the emitter electrode is achieved. The remaining photoresist layer 930, metal layer 915 and substrate 910 are shown in FIG. 9B. The remaining portions of photoresist layer 930 are then removed in step 824.

The gate electrode is then formed. At step 830, a layer of an insulating material 940 is formed on the emitter electrode. Next, a layer of metal 945 is formed at step 832 on insulating layer 940; and at step 834 a second layer of insulating material 950 is formed on metal layer 945.

A photolithographic process is then used to shape metal layer 945 into the gate electrode. First, at step 836, a layer of a suitable photoresist 955 is formed on second insulating layer 950; and the photoresist layer is exposed to a pattern of actinic radiation that defines the shape of the gate electrode. Illustratively, the gate electrode may be an annulus that surrounds the sharp edge 917 of the emitter electrode; but other shapes may be used in the practice of the invention.

The cross-section of a circuit element at this stage in the process is depicted in FIG. 9C.

At step 838, a selective, anisotropic etch is performed to etch second insulating layer 950 down to metal layer 945. At step 840, a selective, anisotropic etch is performed to etch portions of metal layer 945 down to insulating layer 940.

At step 850, the remaining portions of photoresist layer 950 are removed. Next, a cavity is formed. A layer of a thick insulator 955 such as a silicon oxide is formed at step 852 on the upper surface of the structure. A photolithographic process is then used to form a cavity 957 in insulating layer 955. First, at step 854, a layer of a suitable photoresist 960 is formed on second insulating layer 955; and the photoresist layer is exposed to a pattern of actinic radiation that defines the shape of the cavity. At step 856, a selective, anisotropic etch is performed to etch thick insulating layer 955 down to second insulating layer 950 thereby exposing the tip of sharp edge 917 of the emitter electrode.

The result at this stage of the process is shown in the cross-section of FIG. 9D.

A collector electrode is then formed. The remaining portions of photoresist layer 960 are removed at step 860. At step 865, a layer of metal 965 is formed on insulating layer 955. A photolithographic process is then used to shape the collector. First, at step 870, a layer of a suitable photoresist 970 is formed on metal layer 965; and the photoresist layer is exposed to a pattern of actinic radiation that defines the shape of the collector electrode. The result at this stage of the process is shown in FIG. 9E. At step 875, a selective, anisotropic etch is performed to etch metal layer 965 down to insulating layer 955. The remaining portions of photoresist layer 970 are then removed at step 880 leaving the completed circuit shown in FIG. 3B.

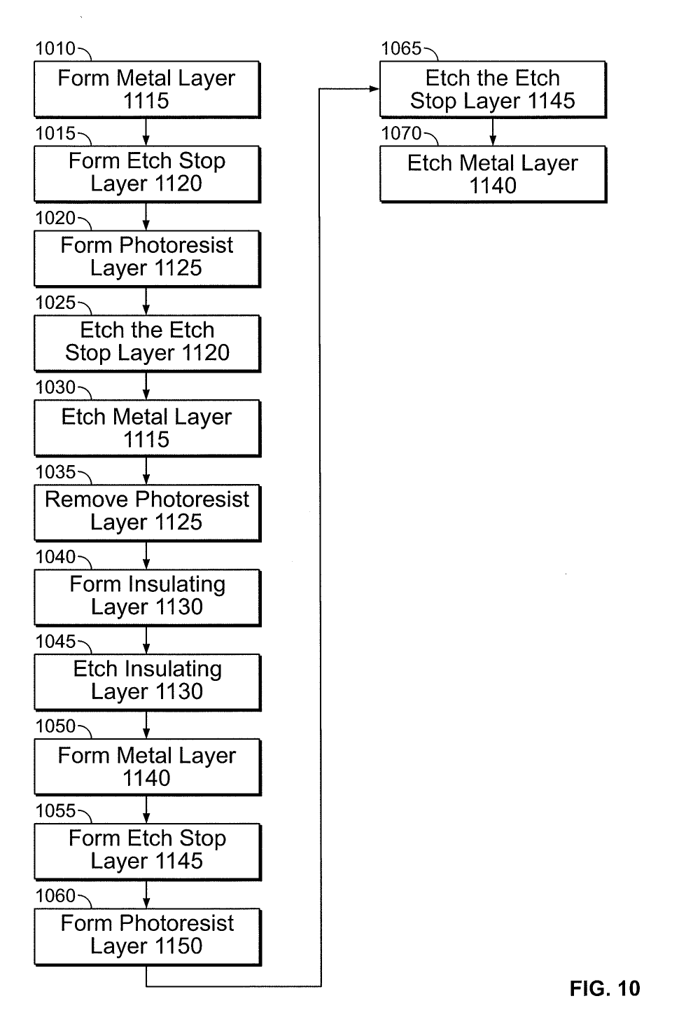

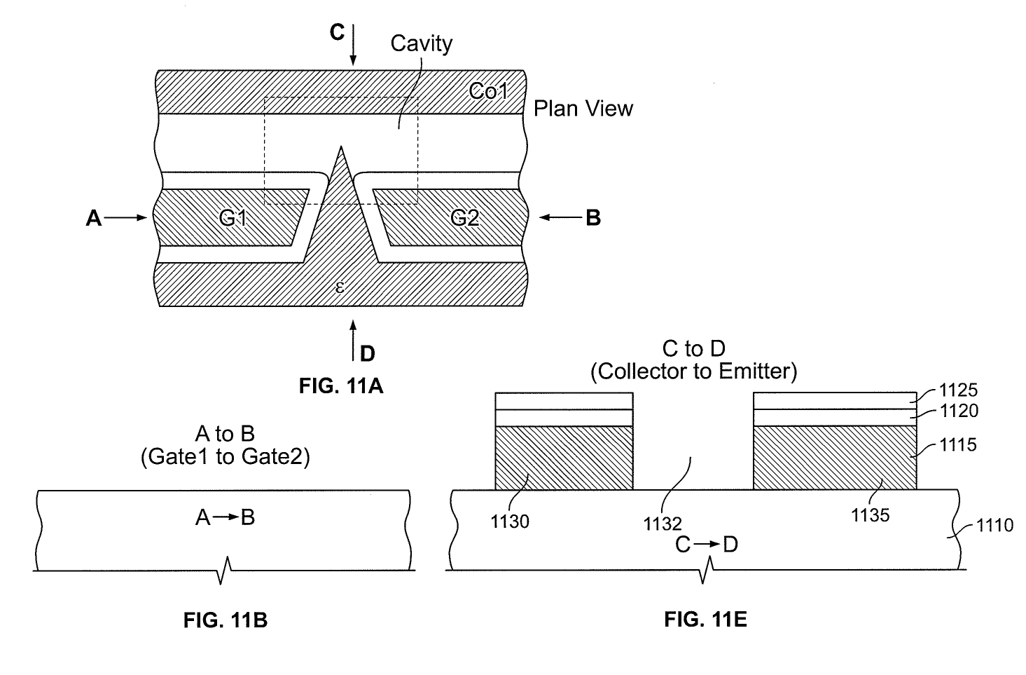

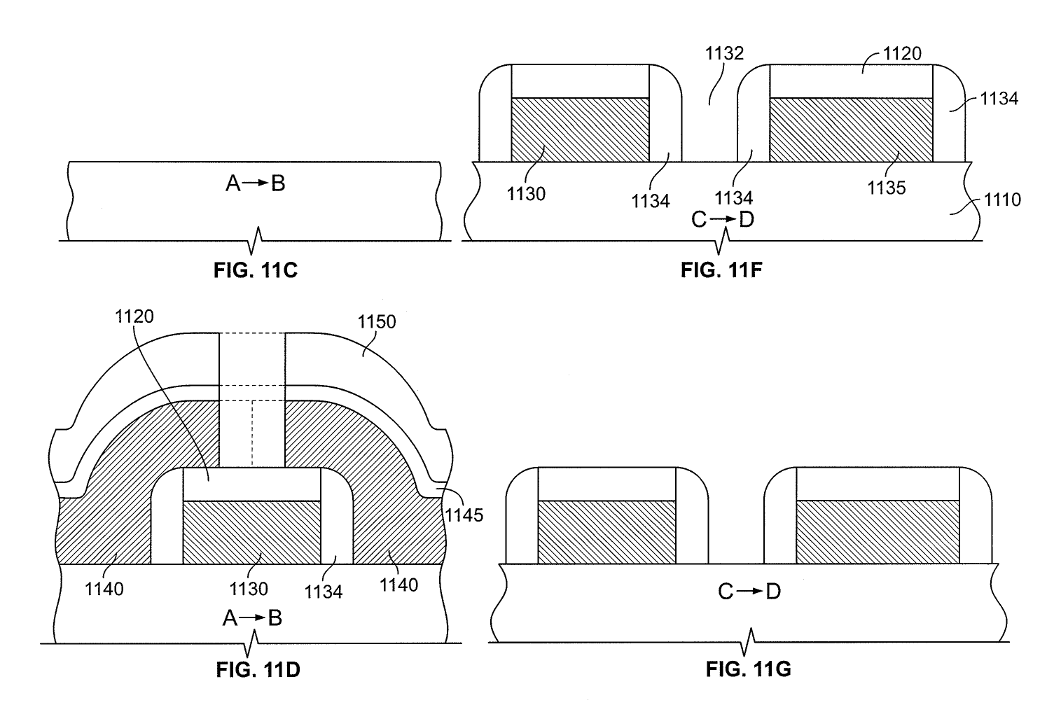

FIG. 10 is a flow chart depicting an illustrative embodiment of another process of the invention for forming a circuit element such as that depicted in the plan view of FIG. 11A. Portions of the description of the flow chart refer to the cross-sectional views of FIGS. 11B-11G where the views of FIGS. 11B-11D are transverse cross-sectional views of the device of FIG. 11A made along line AB of FIG. 11A and the views of FIGS. 11E-11G are longitudinal cross-sectional views made along line CD of FIG. 11A. The process for making a circuit element such as that of FIG. 11A except that the gate electrode is located near the collector electrode instead of near the emitter electrode is similar to the process of FIG. 10.

The process of FIG. 10 begins at step 1010 with the formation of a layer of metal 1115 (see FIG. 11E) on a substantially flat insulating substrate 1110. Metal layer 1115 will be used to form the emitter and collector electrodes. Illustrative examples of suitable metals for use in the layer are copper, aluminum/copper, and tungsten. Illustratively, the substantially flat insulating substrate 1110 can be formed of a silicon oxide or silicon nitride. In one embodiment of the invention, the circuit element may be formed on one of the dielectric layers in the back end structure of interconnects on an integrated circuit. In such an embodiment, the insulating substrate may be formed simultaneously on a multitude of identical integrated circuits that are being formed on a single wafer of a semiconductor material. The insulating substrate may include electrically conducting vias that connect to various portions of the layer of metal that is formed in step 1010.

At step 1015, a nitride etch stop layer 1120 is formed on metal layer 1115. Next, a photolithographic process is used to define the shape of the emitter and collector electrodes. First, at step 1020, a layer of a suitable photoresist 1125 is formed on etch stop layer 1020; and the photoresist layer is exposed to a pattern of actinic radiation that defines the shape of the emitter and collector electrodes. At step 1025, a selective, anisotropic etch is performed to etch layer 1120 down to metal layer 1115. Another selective, anisotropic etch is then performed at step 1030 to etch metal layer 1115 down to substrate 1110 to shape the emitter and collector electrodes.

FIG. 11E is a longitudinal section along line CD of FIG. 11A that depicts emitter electrode 1130 and collector electrode 1135 at this stage in their fabrication with a gap 1132 between them. Illustratively, there is no structure along line AB of FIG. 11A at this stage of the process.

At step 1035, the remaining portions of photoresist layer 1125 are removed. A gate insulating layer 1130 is then formed at step 1040 on the emitter and collector electrodes, on their sidewalls 1117, and on the exposed portion of substrate 1110 such as that in gap 1132. Preferably, insulating layer 1130 is a silicon oxide. The thickness of this layer determines the distance between the gate and the emitter electrodes. At step 1145, an anisotropic etch is performed to remove the portions of insulating layer 1130 that extend in the horizontal direction, thereby exposing the portion of substrate 1110 in gap 1132 and leaving spacers 1134 on the sidewalls of emitter electrode 1130 and collector electrode 1135 as well as the etch stop layer 1120 on the upper surface of these electrodes.

The result is shown in FIG. 11F which is a section along line CD of FIG. 11A. Again, as shown in FIG. 11C, at this stage in the process of FIG. 10 there is nothing on substrate 1010 on the transverse section along line AB of FIG. 11A.

The gate electrode is then formed First, at step 1050, a metal layer 1140 is formed on the sidewall spacers 1134 and etch stop layer 1120 on the emitter electrode 1130. An etch stop layer 1145 is then formed at step 1055 on metal layer 1140.

A photolithographic process is then used to shape the gate electrode. First, at step 1060, a layer of a suitable photoresist 1150 is formed on etch stop layer 1145; and the photoresist layer is exposed to a pattern of actinic radiation that defines the shape of the gate electrode. FIG. 11D is a transverse cross-section along line AB of FIG. 11A that depicts the emitter and gate electrodes at this stage in the process of FIG. 10.

At step 1065, a selective, anisotropic etch is performed to etch the etch stop layer 1145 down to metal layer 1140. At step 1070, a selective, anisotropic etch is performed to etch metal layer 1140 down to etch stop layer 1120, spacers 1134 and substrate 1110 to produce the final shape of the gate electrode as shown in FIG. 11A.

As noted above in the discussion of FIG. 1, there are two types of circuit elements that provide complementary control functions. In a first type where the gate electrode is near the emitter electrode, a high voltage applied to the gate electrode will prevent current flow between the emitter electrode and the collector electrode while a low voltage will permit current flow between the emitter electrode and the collector electrode. Conversely, in a second type of circuit element where the gate electrode is near the collector electrode, a high voltage applied to the gate electrode will permit current flow between the emitter electrode and the collector electrode while a low voltage will prevent current flow between the emitter electrode and the collector electrode. Illustratively, the high voltage is comparable to the voltage applied to the collector electrode and the low voltage is comparable to the voltage applied to the emitter electrode. In describing circuit operation we will follow the convention that the direction of current flow is opposite to the direction of electron flow.

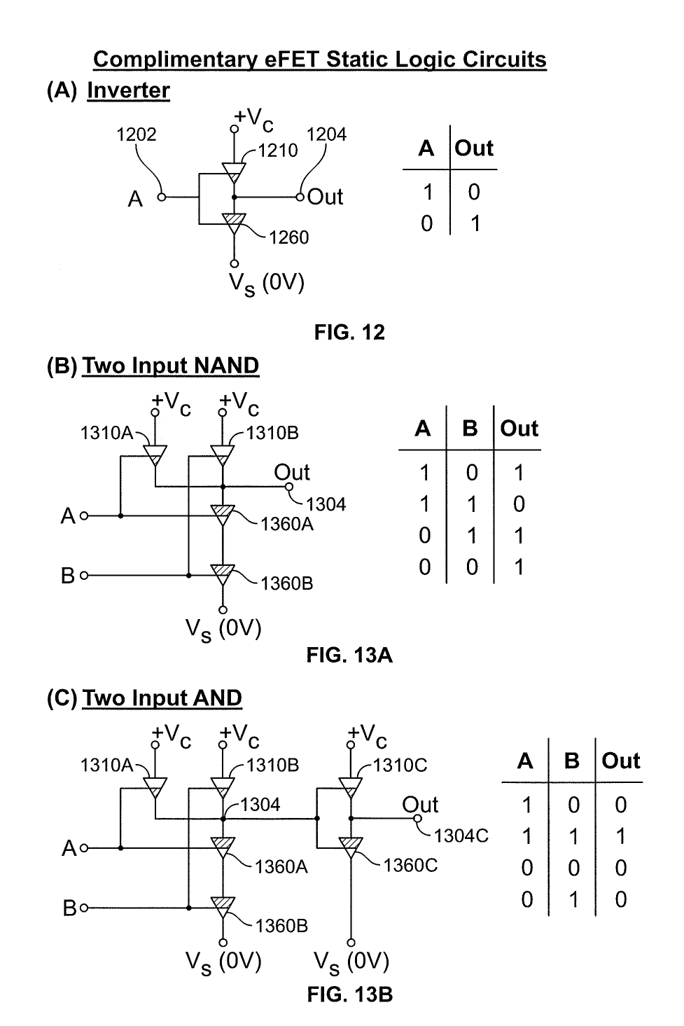

FIG. 12 is an inverter 1200 comprising a series connection of a first-type circuit element 1210 in which the gate is formed near the emitter of the circuit element and a second-type circuit element 1260 in which the gate is formed near the collector of the circuit element. Each circuit element is represented by a triangle with the emitter electrode at one vertex of the triangle, the collector electrode on the triangle edge opposite the emitter vertex, and the gate on one of the edges connecting the emitter vertex and the collector edge. In the case of circuit element 1210, the gate is shown contacting the edge near the emitter vertex and the area of the triangle near the emitter vertex is shaded. In the case of circuit element 1260, the gate is shown contacting the edge near the collector edge and the area of the triangle near the collector edge is shaded.

As shown in FIG. 12, circuit elements 1210 and 1260 are connected between a high voltage and a low voltage with the gate electrodes of elements 1210, 1260 being connected to an input 1202 to the inverter and the collector electrode of element 1260 and the emitter electrode of second element 1210 being connected to an output 1204 of the inverter. When a first voltage is applied to input 1202, the gate electrode of circuit element 1210 will permit electrons to flow from the emitter electrode to the collector electrode of circuit element 1210 while the same voltage applied to the gate electrode of circuit element 1260 will prevent electron flow between the emitter electrode and the collector electrode of circuit element 1260. Thus, there will be current flow from the collector electrode of circuit element 1210 out through output 1204. Illustratively, the first voltage is comparable to the voltage at the emitter electrode of circuit element 1260; and the voltage at output 1204 will be comparable to the voltage at the collector electrode of circuit element 1210.

Conversely, when a second voltage is applied to the gate electrodes of circuit elements 1210, 1260, it will prevent electron flow from the emitter electrode of circuit element 1210 to the collector electrode while the same voltage applied to the gate electrode of circuit element 1260 will permit current flow between the emitter electrode and the collector electrode of circuit element 1260. As a result, there will be current flow in through output 1204 to the emitter electrode of circuit element 1260. Illustratively, the second voltage is comparable to the voltage at the collector electrode of circuit element 1210 and the voltage at output 1204 will be comparable to the voltage at the emitter electrode of circuit element 1260. Thus, when the voltage at input 1202 is comparable to the voltage at the collector electrode of circuit element 1210, the voltage at the output 1204 is comparable to the voltage at the emitter electrode of circuit element 1260; and when the voltage at input 1202 is comparable to the voltage at the emitter electrode of circuit element 1260, the voltage at the output 1204 is comparable to the voltage at the collector electrode of circuit element 1210. Typically, the voltage at the emitter electrode of circuit element 1260 will be approximately 0 Volts or low; and the voltage at the collector electrode of circuit element 1210 will be substantially higher. Thus, circuit 1200 does indeed function as an inverter.

FIGS. 13A, 13B, 14A, 14B, and 15 are schematic diagrams illustrating NAND, AND, NOR, OR and SRAM circuits that use a plurality of circuit elements 1210 and 1260 to achieve the logic functions indicated. The first-type circuit elements are identified by a number ending in “10”; and the second-type circuit elements are identified by a number ending in “60.”

In the NAND circuit of FIG. 13A, a high voltage on inputs A and B will turn off circuit elements 1310A and 1310B and turn on circuit elements 1360A and 1360B, thereby producing a low voltage at output 1304. For any other combination of inputs, one or both of circuit elements 1310A and 1310B will be on and one or both of circuit elements 1360A and 1360B will be off, thereby producing a high voltage at output 1304.

AND circuit of FIG. 13B includes the same circuit elements of FIG. 13A bearing the same identification numbers and an inverter comprising circuit elements 1310C and 1360C connected to output 1304. It will produce a high voltage at output 1304C of the inverter when both inputs A and B are high and a low voltage for all other combinations of inputs.

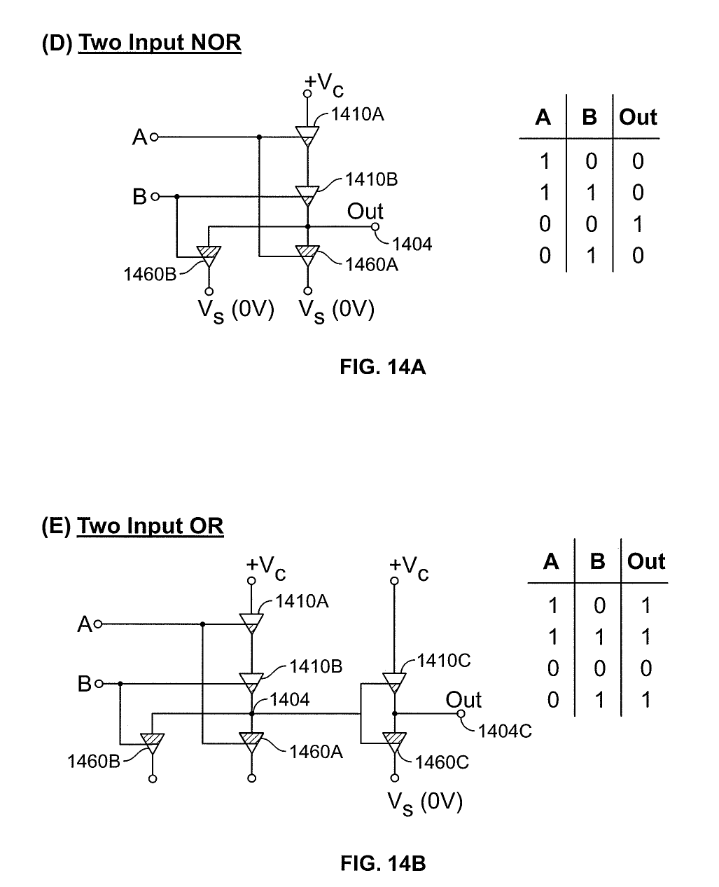

In the NOR circuit of FIG. 14A, a low voltage on inputs A and B will turn on circuit elements 1410A and 1410B and turn off circuit elements 1460A and 1460B, thereby producing a high voltage at output 1404. For any other combination of inputs, one or both of circuit elements 1410A and 1410B will be off and one or both of circuit elements 1460A and 1460B will be on, thereby producing a low voltage at output 1404.

OR circuit of FIG. 14B includes the same circuit elements of FIG. 14A bearing the same identification numbers and an inverter comprising circuit elements 1410C and 1460C connected to output 1404. It will produce a low voltage at output 1404C of the inverter when both inputs A and B are low and a high voltage for all other combinations of inputs.

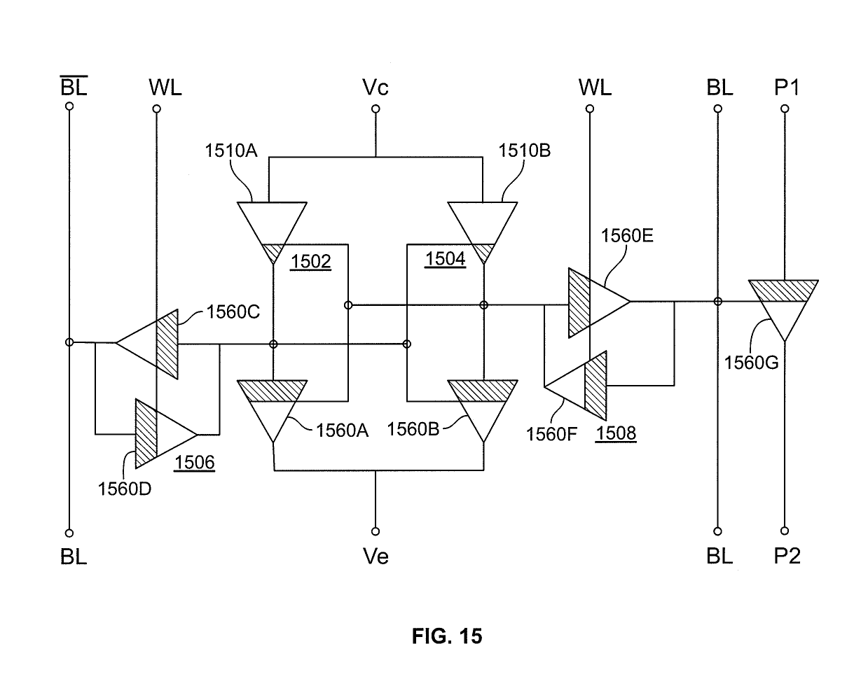

FIG. 15 is a schematic diagram of an SRAM circuit 1500. Circuit 1500 comprises first and second cross-coupled inverters 1502, 1504 and two pairs 1506, 1508 of circuit elements cross-coupled to form pass gates. Inverter 1502 comprises circuit elements 1510A and 1560A; inverter 1504 comprises circuit elements 1510B and 1560B; pair 1506 comprises circuit elements 1560C and 1560D; and pair 1508 comprises circuit elements 1560E and 1560F. A high signal on the write line WL causes both pairs 1506 and 1508 to conduct thereby enabling read and write operations to the cross-coupled inverters 1502, 1504. A high signal from gate 1508 also permits current flow in circuit element 1560G.

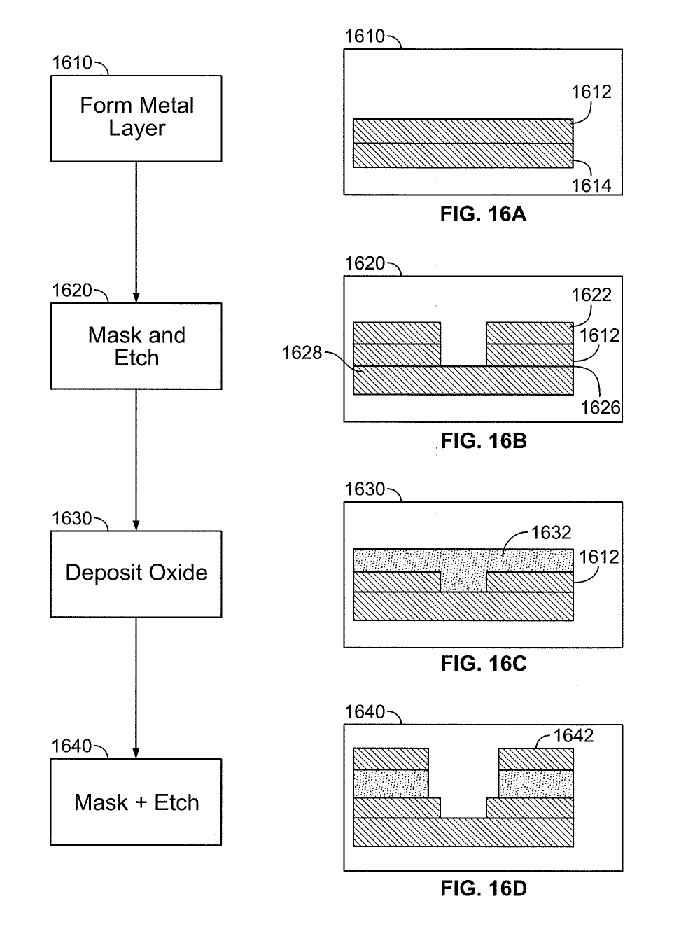

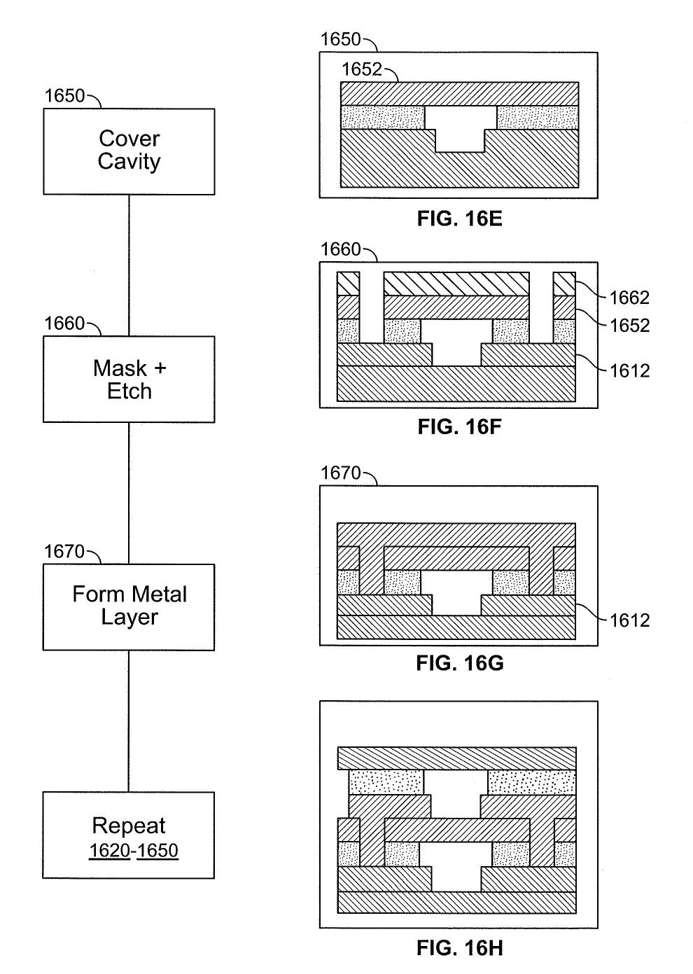

FIGS. 16A-16H are a flowchart and side views depicting the formation of multiple planar circuit elements in accordance with the invention. The process begins at step 1610 with the formation of a layer of metal 1612 on a substantially flat insulating surface 1614 as shown in FIG. 16A. Similar to the process of FIGS. 2A, 2B, 2C, and 2D, the circuit elements may be formed on one or more of the dielectric layers in the back end structure of interconnects on an integrated circuit. In such an embodiment, the insulating surface may be formed simultaneously on a multitude of identical integrated circuits that are being formed on a single wafer of a semiconductor material.

At step 1620, selected portions of the metal layer are removed to define the first, second and gate electrodes of the circuit element. Illustratively, portions of the metal layers are removed by a photolithographic process in which the metal layer is covered with a layer of a suitable photoresist 1622; the photoresist layer is exposed to a pattern of actinic radiation that defines the shape of the first, second and gate electrodes; portions of the photoresist are removed to expose the underlying metal 1624 between the first, second and gate electrodes; and the exposed metal between the electrodes is then etched away as shown in FIG. 16B. The side view of FIG. 16B depicts first and second electrodes 1626, 1628 but does not depict the gate electrode which is located between the first and second electrodes but is not in the plane of FIG. 16B.

At step 1630, the remaining photoresist is removed and an oxide layer 1632 is deposited as shown in FIG. 16C.

At step 1640, another photolithographic process is performed in which the oxide layer is covered with a layer of a suitable photoresist 1642; the photoresist layer is exposed to a pattern of actinic radiation that defines a cavity between the electrodes; portions of the photoresist are removed to expose the underlying oxide; and the exposed oxide is then etched away as shown in FIG. 16D.

The remaining resist is then removed; and at step 1650 a thin plate 1652 of insulator is laid over the cavity 1652 as shown in FIG. 16E.

If additional circuit elements are desired, at step 1660, another layer 1662 of photoresist is formed on plate 1652. This layer is then exposed to a pattern of actinic radiation that defines the location of via holes that extend to the underlying metal layer 1612; portions of the photoresist are removed to expose portions of the underlying plate; and the exposed portions of the plate are then etched away as shown in FIG. 16F.

The remaining photoresist is then removed; and at step 1670 a second layer of metal is deposited that extends across the plate and down through the via holes to make connection with the first metal layer 1612 as shown in FIG. 16G.

Steps 1620, 1630, 1640 and 1650 may then be repeated to form a second circuit element on the second metal layer as shown in FIG. 16H.

Still other circuit elements may be formed by repeating steps 1660, 1620, 1630, 1640 and 1650 as desired.

As will be apparent to those skilled in the art, numerous variations may be practiced within the spirit and scope of the present invention. The cavity between the emitter electrode and the collector electrode may be sealed or not sealed. If it is sealed, the cavity may be evacuated to pressures such as one tenth (0.1) or one hundredth (0.01) atmosphere or even less. In other embodiments of the invention where the distance between the emitter electrode and the collector electrode is quite small, there may be no need for any cavity. In these situations, which can be expected where the spacing between the electrodes is on the order of tens of nanometers or less, the mean free path of an electron traveling between the emitter electrode and the collector is comparable to the distance between the electrodes. As a result, the probability that an electron emitted from the emitter electrode would reach the collector electrode without colliding with something is quite high; and the region between the electrodes operates, in effect, as a partially evacuated cavity.

While it is expected that the invention may advantageously be used in the back end structures of integrated circuits, it will be understood that the invention may also be practiced in other structures as well. And while the circuit examples provided above are logic circuits, it must be emphasized that these circuits are only illustrative and that the invention may also be used in other types of logic circuits as well as in analog circuits. One feature of the three electrode circuit element of the present invention is its very high switching speed which should be very advantageous in analog circuits.

While the invention has been described using various photolithographic processes for fabricating the three electrode circuit elements, it may also be practiced using several alternative processes for forming these circuits elements. These alternative processes include direct e-beam writing of the photoresist using a single e-beam or multiple e-beams operating in parallel; focused ion beams, electron beams, or laser induced deposition to define the metal layers of the electrodes without the need for any photolithographic processes; and other atomic layer deposition techniques.

The invention may be practiced with numerous process modifications in addition to or in place of those described above. In the interest of brevity, many well known details of the processes described above have not been set forth. In addition, details of the connections of the emitter, gate and collector electrodes will be apparent to those skilled in the art.

What is claimed is:

1. A circuit element comprising:
first and second electrodes spaced apart by a distance of less than approximately 200 nanometers;
an insulator between the electrodes; and
a gate electrode near one of the first and second electrodes and insulated from it.

2. The circuit element of claim 1 wherein the first and second electrodes are located in substantially the same plane.

3. The circuit element of claim 1 wherein the first, second and gate electrodes are located in substantially the same plane.

4. The circuit element of claim 1 wherein the first, second and gate electrodes are stacked one above the other with the insulator between them.

5. The circuit element of claim 1 wherein one of the first and second electrodes is shaped or coated or both to stimulate electron emission.

6. A circuit element comprising:
an insulator;
a cavity in the insulator;
first and second electrodes in the cavity spaced apart by a distance less than approximately 200 nanometers; and
a gate electrode near one of the first and second electrodes and insulated from it.

7. The circuit element of claim 6 wherein the first and second electrodes are located in substantially the same plane.

8. The circuit element of claim 6 wherein the first, second and gate electrodes are located in substantially the same plane.

9. The circuit element of claim 6 wherein the first, second and gate electrodes are stacked one above the other with the insulator between them.

10. The circuit element of claim 6 wherein one of the first and second electrodes is shaped or coated or both to stimulate electron emission.

11. A circuit element comprising:
an insulator;
a cavity in the insulator;
first and second electrodes in the cavity spaced apart by a distance such that when operating voltages are applied to the first and second electrodes an electric field is established between the first and second electrodes that is sufficient to cause electron emission from the first electrode; and
a gate electrode near one of the first and second electrodes and insulated from it.

12. The circuit element of claim 11 wherein the first and second electrodes are located in substantially the same plane.

13. The circuit element of claim 11 wherein the first, second and gate electrodes are located in substantially the same plane.

14. The circuit element of claim 11 wherein the first, second and gate electrodes are stacked one above the other with the insulator between them.

15. The circuit element of claim 11 wherein one of the first and second electrodes is shaped or coated or both to stimulate electron emission.

16-20. (canceled)

21. The circuit element of claim 1 wherein the first, second and gate electrodes are formed in a single layer of metallization.

22. The circuit element of claim 1 wherein each of the first, second and gate electrodes is formed in a different layer of metallization.

23. The circuit element of claim 1 further comprising a cavity in the insulator that extends between the first and second electrodes.

24. The circuit element of claim 11 wherein the first, second and gate electrodes are formed in a single layer of metallization.

25. The circuit element of claim 11 wherein each of the first, second and gate electrodes is formed in a different layer of metallization.
